(19) United States
(12) Patent Application Publication
(10) Pub. No.: US 2015/0109257 A1
(43) Pub. Date: Apr. 23, 2015

(54) PRE-TOUCH POINTER FOR CONTROL AND DATA ENTRY IN TOUCH-SCREEN DEVICES

(71) Applicant: Lumi Stream Inc., Toronto (CA)

(72) Inventor: Anoush Jalali, Toronto (CA)

(73) Assignee: Lumi Stream Inc., Toronto (CA)

(21) Appl. No.: 14/061,296

(22) Filed: Oct. 23, 2013

(51) Int. Cl. G06F 3/0354; G06F 3/042

(52) U.S. Cl. CPC G06F 3/03547; G06F 3/042; G06F 2203/0338; G06F 2203/0339
USPC 345/175

(57) ABSTRACT

A “Pre-Touch” pointer method and apparatus for facilitating data entry and control of touch-screen devices. As a user hovers finger(s) above a touch-screen device (before making contact), plurality of sensors detect the finger and based on the physical location of the finger, create a pointer that is offset from the location of finger (to prevent obstruction). Said pointer helps a user target the precisely desired target location by reducing its size as finger(s) approaches the screen. When contact is made by finger(s), the location of said offset pointer remains the same, but it could become invisible—to help prevent obstruction. Its properties can also change to help better visualize or interact with touch-screen devices.

12

### FIELD OF THE INVENTION

The present invention relates to an offset pointer that is visible when a finger(s) is close to electronic touch-screen devices and specifically for precise data entry into touch-screens.

### BACKGROUND OF THE INVENTION

Touch-screen technology has been in development for quite some time. Users have many concerns while working with touch-screen devices like cellular phones, personal digital assistants (PDAs), tablets and pagers, due to screen size and how interaction is currently configured. For example, it is difficult to select a link or button on a crowded screen, or create artwork with current touch-screens, because users' hands and fingers obscure the screen area. An individual may experience clicking the wrong link with his/her finger; which can occur during internet browsing and crowded web pages. The user may want to select a link on the side of the web browser and unintentionally click on a wrong link. These kinds of scenarios happen frequently during interaction with touch-screen devices. Other issues, such as data entry, selecting a place on a map, and drawing images in programs also require accurate finger touches. Data entry for those with a good understanding of new technology is not a concern. They become accustomed to a new technology by trial and error while working with a new device. However, users that have needs for precise data entry, dealing with imprecise interaction is an issue.

Dynamic magnification of the touch-screen is one method of alleviating incorrect interaction. However, it is found to be confusing for users, since areas of the browsing page or screen could become obscured. Another solution for accurate data entry, which may solve the above issue, is to use digital pens to select icons or draw a picture. This technique is suitable for devices that are compatible with a digital stylus. Many prefer to use their fingers instead of a stylus, because of difficulty carrying a stylus at all times and the possibility of misplacing it. Further proposed solutions for facilitating accurate data entry are to offset the window or screen above the target area. These techniques are suitable for internet browsing but have drawbacks for other applications such as digital artwork.

Accordingly, there is a need for a method for accurate data entry for touch-screen devices that solves the above mentioned drawbacks and prevents obstruction of the target area.

### SUMMARY OF THE INVENTION

Exemplary embodiments of the present invention provide a method for facilitating more precise data entry into electronic touch-screen devices while preventing obstruction. An offset pointer, which is positioned above the finger, is displayed on touch-screen devices when a finger(s) is close to the screen. The offset pointer allows a user to easily see the exact position where his/her finger is going to activate before touching the screen.

More specifically, users get a better idea of the exact location they are targeting by seeing the offset target location before touching the screen. This will help them know and if needed, adjust their finger's position relative to the touch-screen, before making contact—helping precisely target the needed location. This invention helps users touch the intended location on a screen by letting them continuously observe the target touch location before their finger(s) touches the screen.

A method is provided for detecting a finger(s) position above a touch-screen when it approaches. By detecting the location of the finger before it touches the screen, a pointer appears on the screen. The pointer gradually reduces in size as the finger moves closer to the screen, showing the exact location of the targeted area before contact. When the finger makes contact with the screen, the reduced pointer fades away from the screen—to prevent obstruction.

The first objective of the present invention is to provide an easier method for creative use of touch-screen devices to facilitate data entry and helping make complicated drawings and creative. Because the pointer is offset from the user's finger, the path of the drawing location can be easily observed, even after contact is made with touch-screens.

The second objective of the present invention is to provide a more precise interaction between fingers and touch-screens for accurate data entry. Users need to be sure that the target area is exactly as intended.

The third objective of the present invention is to provide better visibility for users working with an electronic device touch-screen. By providing an offset pointer that has a size, shape or color that changes as a finger(s) approaches the touch-screen, the exact location of the finger and the pointer is continuously observed by the user.

The fourth objective of the present invention is to provide a more friendly interaction between users and devices due to the visibility of the offset pointer on the device.

The aforementioned objects of the present invention are attained by the Pre-Touch offset pointer into electronic touch-screen devices. Other objects, advantages and novel features of the present invention will become readily apparent from the following drawings and detailed description of referred embodiments.

### BRIEF DESCRIPTION OF DRAWINGS

Embodiments herein will be described in conjunction with the appended drawings provided to illustrate and not to limit the scope of the claims, wherein like designations denote like elements, and in which:

FIG. 1 shows a hardware-software operation of new Pre-Touch pointer design;

FIG. 2 shows an exemplary embodiment of new touch-screen Pre-Touch pointer when drawing;

FIG. 3 shows an exemplary embodiment of new touch-screen Pre-Touch pointer technique when internet browsing; and

FIG. 4 shows an offset pointer operation sequence diagram.

### DETAILED DESCRIPTION OF PREFERRED EMBODIMENTS

Some of the embodiments of the present invention will be described in detail with reference to figures, but not all embodiments of the inventions are shown. The present invention can also be embodied in many different constructions and configurations to not limit the scope of claims.

The description regarding exemplary embodiment of the present invention is provided by interaction of the user with the electronic touch-screen device. Such an interaction with the touch-screen device is described for illustration purposes. The finger and screen are elements which are involved in the description of the present invention.

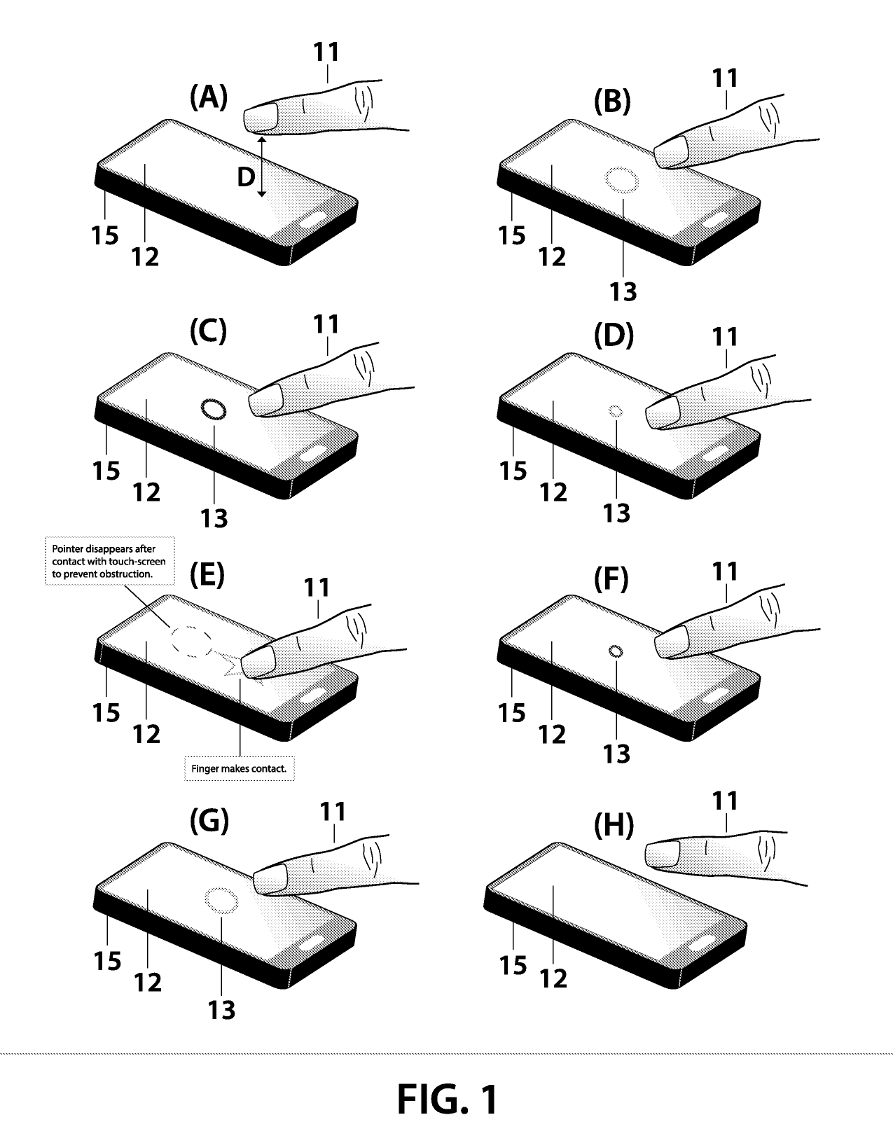

FIG. 1 shows the hardware and software operation of the present invention. The whole process of the present invention is described in FIG. 1. Based on the distance (D) between a finger 11 which hovers above a touch-screen (without touching it) 12, the new offset pointer design displays and exhibits different behavior based on the distance between finger(s) and touch screen. By monitoring the pointer 13, the user can find out the exact location of the target area 13 on the touch-screen 12 and adjust their finger(s) before making contact—achieving perfect accuracy.

Again referring to FIG. 1(B), when the finger 11 is away from the touch-screen 12, no pointer is visible. The operational distance between finger 11 and touch-screen 12 can be determined by software. The distance between the finger 11 and touch-screen 12 should be at a predefined distance to be detected by sensors of the touch-screen device 15. As shown in FIG. 1(C) when finger 11 gets closer to the screen 12, an offset pointer 13 starts fading in and when finger 11 gets even closer to screen 12, the pointer 13 gets solid and smaller as shown. When finger 11 is about to make contact with the screen 12 as shown in FIG. 1(D), the pointer 13 gets slightly transparent and even smaller. This is the exact location of the pointer on the touch-screen 12 and the user can make sure that the targeted area is selected correctly as shown in FIG. 1(D). When contact is made with screen 12, the pointer 13 disappears as is shown in FIG. 1(E), and when finger 11 gets away from screen again 12, the offset pointer 13 re-appears as shown in FIG. 1(G). When the finger is lifted further away from the touch-screen, the cursor 13 could fade away as show in FIG. 1(H)—this prevents obstruction of the screen.

The newly designed pointer 13 can be different shapes and sizes based on the device configuration or user's preference. The purpose of the pointer 13 is better visibility, preventing obstruction, and precise interaction of the finger 11 with the targeted area on the touch-screen 12.

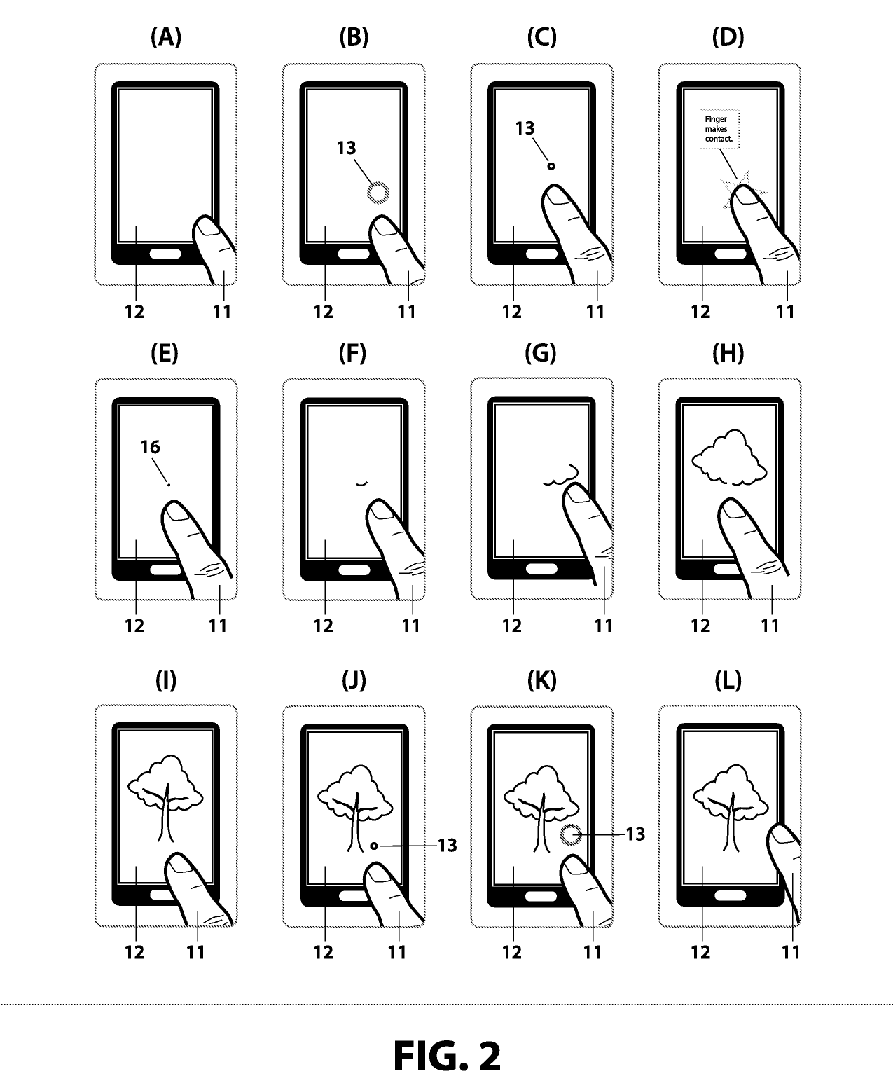

FIG. 2 shows an exemplary embodiment of the newly designed pointer for drawing purposes. As shown in FIG. 2(A-L), a touch-screen device is on and a drawing application has been opened. As the finger 11 approaches the touch-screen device, an offset pointer 13 fades-in. As the finger 11 gets closer to the touch-screen device, the pointer 13 gets smaller. When the finger 11 makes contact with the screen 12, the pointer 13 disappears as shown in FIG. 2 (D). A drawing mark 16 appears where the pointer used to be as shows in FIG. 2 (E). As the finger 11 is dragged across the screen 12, the drawing continues as shown in FIG. 2 (H). The drawing point remains offset from the finger 11 in the contact area. As the finger 11 is lifted off the touch-screen device, the offset pointer 13 fades in again as shown in FIG. 2 (J). As the finger 11 gets further away from the touch-screen 12, the pointer 13 gets larger. When the finger 11 gets even further away from the touch- screen 12 the pointer 13 disappears as shown in FIG. 2 (L).

Precise line drawing is possible with the present invention. As shown in FIG. 2, the user can start the drawing from any part of the digital canvas. Without an offset pointer, the exact location of the finger cannot be determined and drawing a complicated picture becomes very difficult. Using this invention, a user's finger movement can be determined with precision.

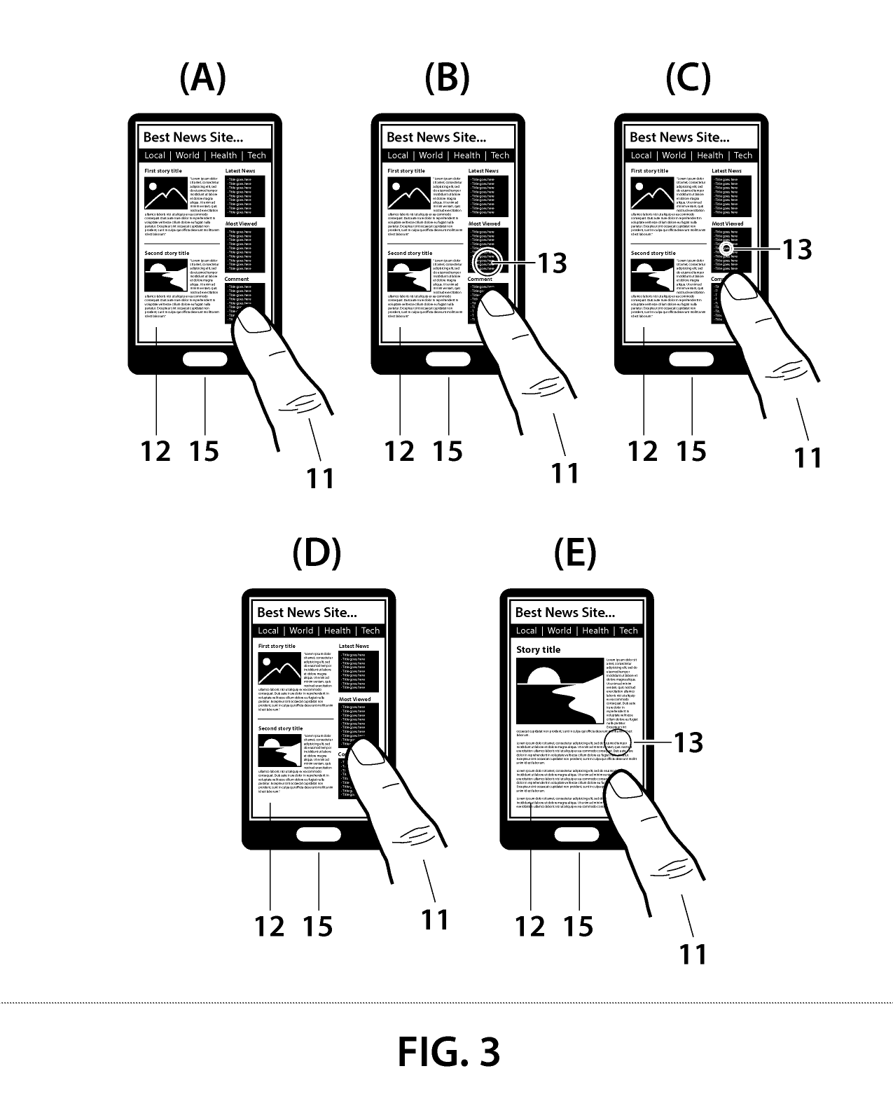

FIG. 3 shows an exemplary embodiment of the present invention when internet browsing. As shown in FIG. 3 (A-E) the finger 11 is positioned away from the touch screen device 15 with an internet browser application open. As the finger 11 gets closer to the screen 12, a pointer 13 fades in that is offset on the screen, above the finger. When the user decides on what they want to click and get closer to the screen 12, the offset pointer 13 gets smaller to provide a more precise location of the targeted area. Once contact is made with the screen, the pointer fades away and the selected page loads. If the finger is hovered away from the screen again 12, the cursor 13 fades-in.

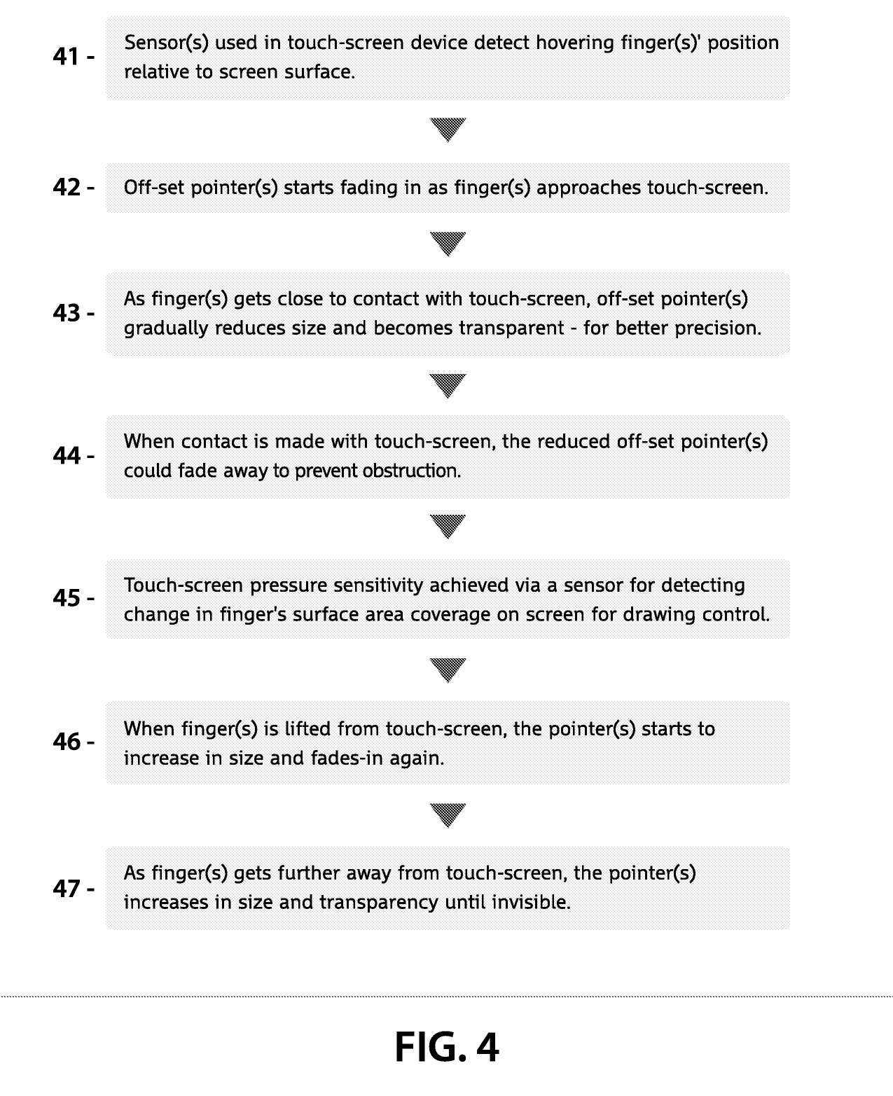

FIG. 4 shows an offset pointer operation sequence diagram. Sensors 41 used in the touch-screen, detect the finger(s) position relative to touch-screen. Pointer 42 starts to fade-in as finger approaches touch-screen. As the finger gets close to making contact, the pointer gradually reduces size and increases transparency as described in step 43. In step 44, when contact is made with touch-screen, the reduced pointer fades away.

For detection of finger(s) above touch-screens, the present invention uses the capability of capacitive technology. Plurality of technologies can be used for the detection of a finger(s) above the touch-screen and the continuous monitoring of finger movement. Sensors 41 detect finger(s) above the touch-screen, they also detect the distance between the finger and touch-screen to change the size of a pointer 42—for better precision.

The computer program manages the offset distance between the finger and the touch-screen by continuously monitoring the movement of the finger and the distance between the finger and touch-screen. When contact is made with the touch-screen, the pointer fades away.

Many technologies are available in the market to detect hovering fingers above touch-screens. Relying on visible light or infrared light; some use sound waves, cameras, or force sensors. The exact location of the finger can be detected with current touch technology and the computer program that matches the last location of the reduced pointer with the location of the finger and keeps the offset pointer in a specific location based on the finger's position.

Again referring to FIG. 4, upon finger contact, step 44, the offset location of the finger remains the same, the offset location of the reduced pointer and the relationship between the pointer and the finger is monitored constantly by the device's processor(s) and sensor(s). In steps 46 and 47, by removing the finger from the touch-screen, sensors detect the hovering finger. Then, based on the distance between the finger and the touch-screen, the pointer size and transparency change to help with interaction precision and prevent obstruction.

Another embodiment of the present invention may be an apparatus for facilitating data entry via a touch-screen device comprising a processor and a computer programming that cause the apparatus to perform specific operations.

The foregoing is considered as illustrative only of the principles of the invention. Further, since numerous modifications to the Pre-Touch pointer could be made by those that have an understanding of this invention, it is not desired to limit the invention to the exact construction and operation shown and described, and accordingly, all suitable modifications and equivalents may be resorted to falling within the scope of the invention.

With respect to the above description, it is to be realized that the optimum relationship for parts of the invention with regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A Pre-Touch pointer method for facilitating data entry via a touch-screen device comprising steps of:
a. detecting a finger hovering above of the touch-screen device within a predefined space;
b. identifying the location on the touch-screen right below the finger as a touching location;
c. monitoring movement of said finger above of the touch-screen device;
d. creating a computer generated offset pointer on the touch-screen device;
e. offsetting the location of said pointer from said touching location;
f. reducing the size of said offset pointer on the touch-screen device as said finger gets closer to said touch-screen device; and
g. moving said offset pointer along with the movement of said finger on the touch-screen device, whereby said offset pointer being in a shifted location with respect to the location of said finger on the touch-screen.

2. The method of claim 1, wherein said predefined space comprises of a three dimensional space above said touch-screen device having the same area as the touch-screen and at least two centimeters above the touch-screen device.

3. The method of claim 1, having a plurality of sensors to continuously scan said predefined space above said touch-screen device to detect the location of said finger(s).

4. The method of claim 1, wherein offsetting the location of said pointer from the touching location of said finger being offset upward, downward, left or right of the touching location.

5. The method of claim 1, wherein said pointer having different shapes and sizes based on a user or a device preference.

6. The method of claim 1, wherein the size and transparency of said pointer reduces as the finger approaches said touch-screen and increases in size by moving the finger away from said touch-screen.

7. The method of claim 1, wherein said pointer could be hidden once said finger makes contact with said touch-screen to prevent obstruction.

8. An apparatus for facilitating data entry via a touch-screen device comprising of:
a. a processor;
b. a plurality of sensors built into the touch-screen device; and
c. a computer code to cause the apparatus to perform at least the following:
i. detecting a finger hovering above of the touch-screen device within a predefined space;
ii. identifying the location on the touch-screen right below the finger as a touching location;
iii. monitoring movement of said finger above of the touch-screen device;
iv. creating a computer generated offset pointer on the touch-screen device;
v. offsetting the location of said pointer from said touching location;
vi. reducing the size of said offset pointer on the touch-screen device as said finger gets closer to said touch-screen device; and
vii. moving said offset pointer along with the movement of said finger on the touch-screen device, whereby said offset pointer being in a shifted location with respect to the location of said finger on the touch-screen.

9. The apparatus of claim 8, wherein said predefined space comprises of a three dimensional space above said touch-screen device having the same area as the touch-screen and at least two centimeters above the touch-screen device.

10. The apparatus of claim 8, having a plurality of sensors to continuously scan said predefined space above said touch-screen device to detect the location of said finger(s).

11. The apparatus of claim 8, wherein offsetting the location of said pointer from the touching location of said finger being offset upward, downward, left or right of the touching location.

12. The apparatus of claim 8, wherein said pointer having different shapes and sizes based on a user or a device preference.

13. The apparatus of claim 8, wherein the size and transparency of said pointer reduces as the finger approaches said touch-screen and increases in size by moving the finger away from said touch-screen.

14. The apparatus of claim 8, said pointer could be hidden once said finger touches said touch-screen to prevent obstruction.
